(19) United States
(12) Patent Application Publication
(10) Pub. No.: US 2018/0018356 A1
(43) Pub. Date: Jan. 18, 2018

(54) RELATIONAL DATABASE ONLINE STORAGE MANAGER

(71) Applicant: DEEPSPACE STORAGE SYSTEMS INC., Huntington Beach, CA (US)

(72) Inventor: STEPHEN CRANAGE, Colorado Springs, CO (US)

(73) Assignee: DEEPSPACE STORAGE SYSTEMS INC., Huntington Beach, CA (US)

(21) Appl. No.: 15/208,897

(22) Filed: Jul. 13, 2016

(51) Int. Cl. G06F 17/30

(52) U.S. Cl. CPC G06F 17/30312; G06F 17/30952; G06F 17/30864; G06F 17/3007; G06F 17/30563; G06F 17/30289; G06F 17/30592

(57) ABSTRACT

A mechanism for managing the growth of databases allows the user to drop tables containing less active data without actually losing access to the data that existed within the table. The storage manager takes the form of a proxy that is configured to reside in the stream between the database client application and the database server. The storage manager acts by intercepting the DROP TABLE command within the SQL and acts to archive the contents of the table prior to passing the command on to the database server for normal execution. Subsequent database queries are monitored for references to tables that have been previously archived. When needed, the storage manager can restage the data from the archive and recreate the table that had been previously dropped in the same form as it had existed prior to that DROP TABLE command execution.

### BACKGROUND OF THE INVENTION

### 1. Field of the Invention

One or more embodiments of the invention relates generally to data storage solutions. More particularly, the invention relates to systems and methods for providing a seamless and cost effective solution for data warehouses to maintain vast amounts of database records without having to implement exotic or expensive purpose-built database management systems or to have to maintain large and expensive primary data storage architectures.

### 2. Description of Prior Art and Related Information

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Databases that store information which is constantly being added to over time have storage management problems. Eventually, older data must be removed to make room for newer data or the database will eventually reach a size that makes its management difficult or impossible.

This is a common problem with databases that are used in decision support systems, where detailed customer records are accumulated over time and are added to continuously. The typical solution to this problem is to summarize older records, and once the summary data has been generated, drop the older tables containing the detailed data. This typical process is effective in controlling the growth of the database, but access to the older records is subsequently lost, or at least limited to the summary data.

Hierarchical Storage Management systems have been in existence for some time. These systems transparently manage the archiving and restoration of the file system files. Since database tables can reside on managed file systems, it is possible to achieve some level of storage management in this manner. However, since the archive manager and database are not specifically designed to work together, implementation of this type of system is very complex and often problematic, incurring many unintended consequences if the mapping of a table to files and specific file policies are not exactly what it needs to be for the desired behavior.

Another possible solution to the problem of database size expansion is the deployment of a relational database that has an archive subsystem directly incorporated into the database engine. These have existed, but have been very expensive and required the replacement of any legacy database server with a completely new database server implementation, which is disruptive and requires a complete copy of all data from the existing system to the new system.

In view of the foregoing, it is clear that there is a need for a system and method for controlling database size, where a hierarchical storage manager acts as a storage management proxy for existing database server systems without requiring any changes to existing database servers.

### SUMMARY OF THE INVENTION

Embodiments of the present invention provide a system for database management comprising a storage manager configured to receive queries of a database from a database client; and a data repository configured to send and receive tables from the storage manager, wherein when the storage manager receives, from the database client, a request either through a command to drop a table from the database using common database syntax or through extension of the database language by addition of data staging commands, the storage manager retrieves the table from the database and stores the table in a storage manager; and when the storage manager receives a query made by a database client to access data in the table dropped from the database, the storage manager restores the table to the database before forwarding the query thereto.

Embodiments of the present invention further provide a method for managing size of a database comprising intercepting, by a storage manager, a request either through a command to drop a table from the database using common database syntax or through extension of the database language by addition of data staging commands; retrieving the data from the database before issuing the command to the database; storing the table into a data repository; and issuing the original request to the database once the data staging operation is complete.

Embodiments of the present invention also provide a method for maintaining a database comprising intercepting, by a storage manager, a request either through a command to drop a table from the database using common database syntax or through extension of the database language by addition of data staging commands; retrieving the data from the database before issuing the command to the database; storing the table into a data repository; storing a table name of the table into a dropped table list of the storage manager; issuing the command to the database; intercepting a query of the database made by a database client; determining whether the query is of a dropped table no longer in the database but stored in the data repository; when the query is of a dropped table, retrieving the dropped table from the data repository, restoring the dropped table to the database, and sending the query to the database; and when the query is of a non-dropped table, sending the query to the database.

In some embodiments, the step of determining whether the query is of the dropped table includes sending the query to the database and, if a table not found error is generated by the database, intercepting the error and making a positive determination that the query is of the dropped table.

In some embodiments, the dropped table is restored to a temporary space in the database.

These and other features, aspects and advantages of the present invention will become better understood with reference to the following drawings, description and claims.

### BRIEF DESCRIPTION OF THE DRAWINGS

Some embodiments of the present invention are illustrated as an example and are not limited by the figures of the accompanying drawings, in which like references may indicate similar elements.

FIG. 1 shows a block diagram illustrating an exemplary configuration of a relational database online storage manager (RDBOSM) between a database client and a database accessed by the database client;

FIG. 2 shows a block diagram of the RDBOSM system of FIG. 1, illustrating specific components of the RDBOSM;

FIG. 3 shows a relational database online storage manager block diagram table drop logic flow according to an exemplary embodiment of the present invention;

FIG. 4 shows a relational database online storage manager query on dropped table logic flow according to an exemplary embodiment of the present invention; and

FIG. 5 shows a relational database online storage manager query on on-line table logic flow according to an exemplary embodiment of the present invention.

Unless otherwise indicated illustrations in the figures are not necessarily drawn to scale.

The invention and its various embodiments can now be better understood by turning to the following detailed description wherein illustrated embodiments are described. It is to be expressly understood that the illustrated embodiments are set forth as examples and not by way of limitations on the invention as ultimately defined in the claims.

### DETAILED DESCRIPTION OF THE PREFERRED EMBODIMENTS AND BEST MODE OF INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention, and is not intended to limit the invention to the specific embodiments illustrated by the figures or description below.

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary, a variety of optional components are described to illustrate the wide variety of possible embodiments of the present invention.

A “computer” or “computing device” may refer to one or more apparatus and/or one or more systems that are capable of accepting a structured input, processing the structured input according to prescribed rules, and producing results of the processing as output. Examples of a computer or computing device may include: a computer; a stationary and/or portable computer; a computer having a single processor, multiple processors, or multi-core processors, which may operate in parallel and/or not in parallel; a general purpose computer; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a portable computer; a tablet personal computer (PC); a personal digital assistant (PDA); a portable telephone; application-specific hardware to emulate a computer and/or software, such as, for example, a digital signal processor (DSP), a field programmable gate array (FPGA), an application specific integrated circuit (ASIC), an application specific instruction-set processor (ASIP), a chip, chips, a system on a chip, or a chip set; a data acquisition device; an optical computer; a quantum computer; a biological computer; and generally, an apparatus that may accept data, process data according to one or more stored software programs, generate results, and typically include input, output, storage, arithmetic, logic, and control units.

“Software” or “application” may refer to prescribed rules to operate a computer. Examples of software or applications may include: code segments in one or more computer-readable languages; graphical and or/textual instructions; applets; pre-compiled code; interpreted code; compiled code; and computer programs.

The example embodiments described herein can be implemented in an operating environment comprising computer-executable instructions (e.g., software) installed on a computer, in hardware, or in a combination of software and hardware. The computer-executable instructions can be written in a computer programming language or can be embodied in firmware logic. If written in a programming language conforming to a recognized standard, such instructions can be executed on a variety of hardware platforms and for interfaces to a variety of operating systems. Although not limited thereto, computer software program code for carrying out operations for aspects of the present invention can be written in any combination of one or more suitable programming languages, including an object oriented programming languages and/or conventional procedural programming languages, and/or programming languages such as, for example, Structure Query Language (SQL) Hypertext Markup Language (HTML), Dynamic HTML, Extensible Markup Language (XML), Extensible Stylesheet Language (XSL), Document Style Semantics and Specification Language (DSSSL), Cascading Style Sheets (CSS), Synchronized Multimedia Integration Language (SMIL), Wireless Markup Language (WML), Java™, Jini™, C, C++, Smalltalk, Python, Perl, UNIX Shell, Visual Basic or Visual Basic Script, Virtual Reality Markup Language (VRML), ColdFusion™ or other compilers, assemblers, interpreters or other computer languages or platforms.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). The program code may also be distributed among a plurality of computational units wherein each unit processes a portion of the total computation.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Further, although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

It will be readily apparent that the various methods and algorithms described herein may be implemented by, e.g., appropriately programmed general purpose computers and computing devices. Typically, a processor (e.g., a microprocessor) will receive instructions from a memory or like device, and execute those instructions, thereby performing a process defined by those instructions. Further, programs that implement such methods and algorithms may be stored and transmitted using a variety of known media.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The term “computer-readable medium” as used herein refers to any medium that participates in providing data (e.g., instructions) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASHEEPROM, any other memory chip or cartridge, a carrier wave as described hereinafter, or any other medium from which a computer can read.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols, such as Bluetooth, TDMA, CDMA, 3G.

As used herein, the “client-side” application and “client”, such as a “database client” should be broadly construed to refer to an application, a page associated with that application, or some other resource or function invoked by a client-side request to the application. A client may operate on a computer or computing device, as defined above.

Embodiments of the present invention may include apparatuses for performing the operations disclosed herein. An apparatus may be specially constructed for the desired purposes, or it may comprise a general-purpose device selectively activated or reconfigured by a program stored in the device.

Unless specifically stated otherwise, and as may be apparent from the following description and claims, it should be appreciated that throughout the specification descriptions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory or may be communicated to an external device so as to cause physical changes or actuation of the external device.

Broadly, embodiments of the present invention provide a mechanism for managing the growth of databases by allowing the user to drop tables containing less active data without actually losing access to the data that existed within the table. The storage manager takes the form of a proxy that is configured to reside in the stream between the database client application and the database server. Its presence is typically transparent to both the client and the server, being accommodated by configuring the network address accordingly.

The storage manager acts by intercepting the DROP TABLE (or equivalent) command within the database systems native i.e., structure query language (SQL) or extended command syntax and acts to archive the contents of the table prior to passing the command on to the database server for normal execution.

Subsequent database queries are monitored for references to tables that have been previously archived. Normally, such a query would return an error, indicating that a non-existent table had been referenced because the table has been dropped previously. The storage manager intervenes before this error is seen by the client application by restaging the data from the archive and recreating the table that had been previously dropped in the same form as it had existed prior to that DROP TABLE command execution. The invention also anticipates extension of the structure query language to add a data staging command that would allow command triggered pre-staging of the archived table data in advance of query execution.

The storage manager typically does not require any changes to existing database servers other than a simple network reconfiguration. There is no need for rewriting database engines or query language. Decoupling a relational database from its primary storage system, via the storage manager of the present invention allows for never before seen database scale with reduced hardware costs (by, for example, using fewer primary storage devices), reduced power requirements (by, for example, enabling the use of removable media and powered-off media for storage targets), and increased database effectiveness (where dropped tables are retained with real data instead of data summarization). Customers with limited budgets for storage media, limited floor space, and/or limited facility power can keep detailed data in their databases, no longer have to summarize tables based off of current implementations, and can keep decades and centuries of real data.

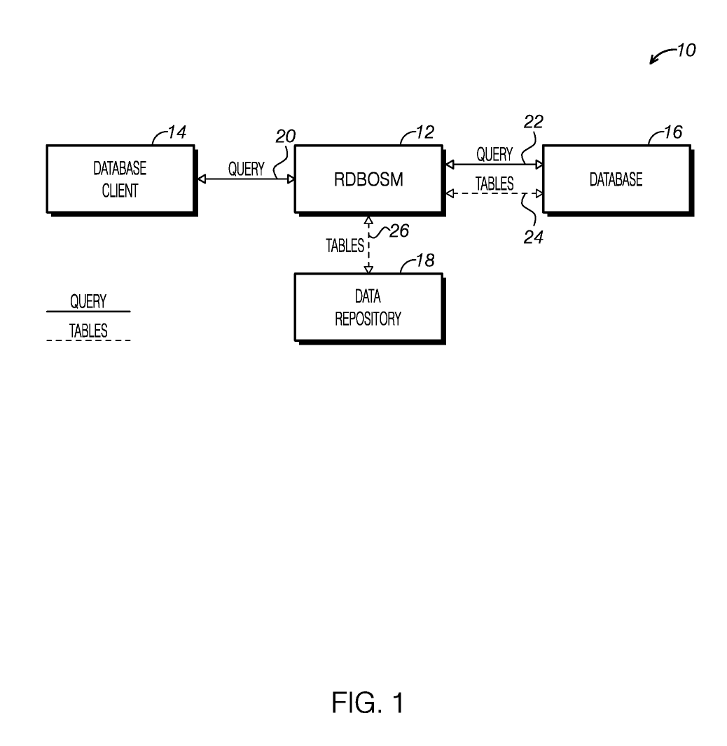

As shown in FIG. 1, a data storage system 10 can include a storage manager 12, also referred to as a relational database online storage manager 12, or RBDOSM 12 that can be easily inserted into existing systems by changing the client application network configuration so the traffic is directed from a client database 14 to the storage manager 12, with the storage manager 12 then configured to the existing database server 16.

When a DROP TABLE command is executed, the storage manager 12 can transparently retrieve the tables via data flow 24, archive these tables, via data flow 26, to a data repository 18, and then send the DROP TABLE command to the database 16. The storage manager 12 can restore the tables via a reverse process when a query, via query flow 20, 22 returns with a table not found error. More specifically, when the database client 14 queries the database 16 for information in a table that was previously dropped (and, therefore, archived by the storage managerl 2), the table not found error is intercepted by the storage manager 12, the table is recovered and placed back to the database 16 via data flow 24, and the query is resubmitted, via query flow 22, to the database 16. This time, because there is no error, the response to the query is appropriately returned to the database client 14.

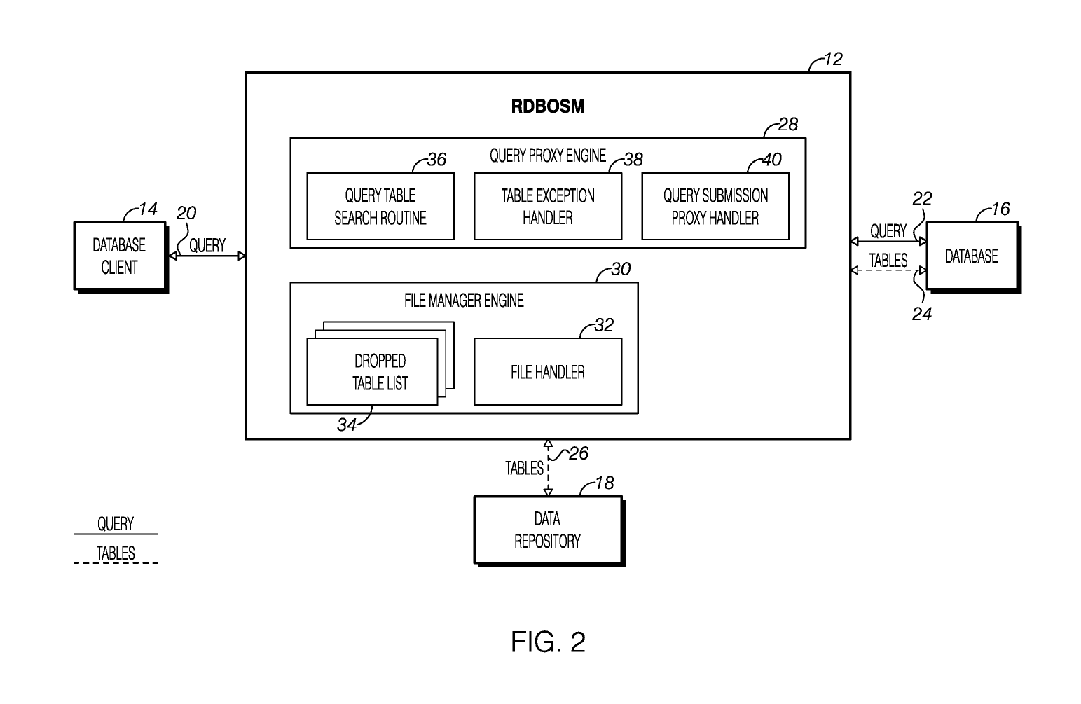

Referring now to FIG. 2, an exemplary embodiment of the storage manager 12 is shown in greater detail. In some embodiments, the storage manager 12 can include a query proxy engine 28 and a file manager engine 30. The query proxy engine 28 can include several modules, including a query table search routine 36, for receiving a query from the database client 14, and a query submission proxy handler 40 for sending the query onto the database 16. A table exception handler 38 may receive an error, such as a table not found error, from the database 16 and activate the file manager engine 30 to restore the table to the database 16. Once the table is restored, the table exception handler 38 may direct the query submission proxy handler 40 to resubmit the query to the database 16.

The file manager engine 30 may include a dropped table list 34 where, when tables that are dropped by a DROP TABLE command are archived, via the file handler 32, to the data repository 18, a table name is stored in the dropped table list 34. The dropped table list 34 may help the query proxy engine 28 know that, when a table not found error is received, whether that table name is archived in the data repository.

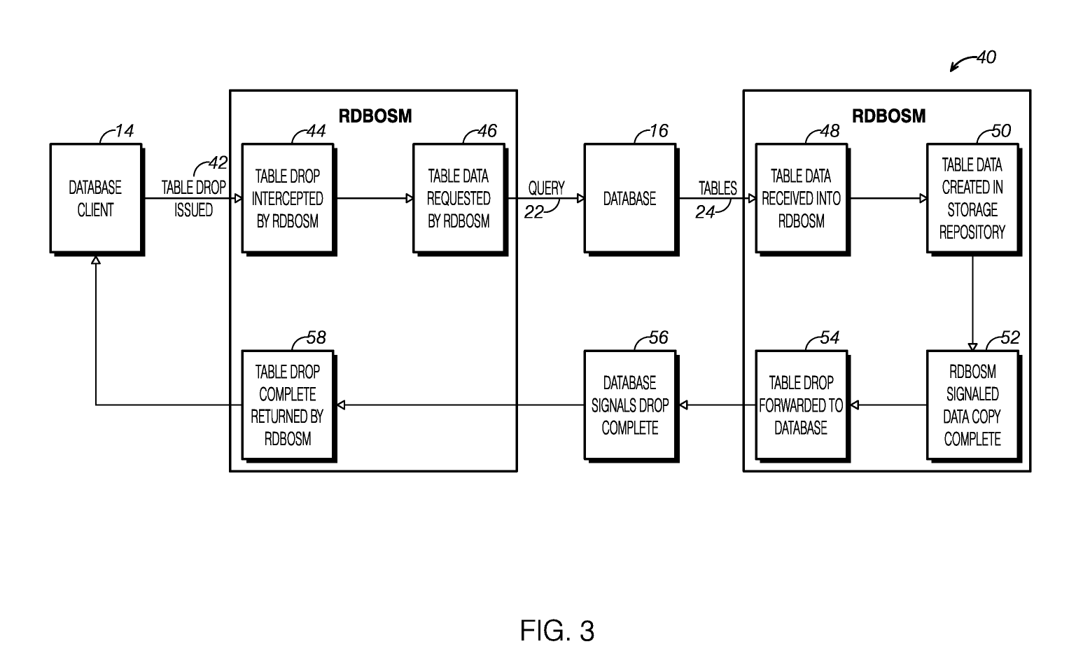

Referring to FIG. 3, a logic flow diagram 30 shows how the storage manager 12 is inserted into a database query when the database client 14 orders a DROP TABLE command 42. Once the command 42 is issued by the database client 14, the command is intercepted by the storage manager 12 at step 44. At step 46, the table data is requested by the storage manager 12 in a query 22 to the database 16. The database 16 sends tables 24 to the storage manager 12. At step 48, the table data is received into the storage manager 12. This table data is created in a storage repository at step 50. Once the storage manager 12 receives a signal that the data copy is complete, at step 52, the DROP TABLE command is forwarded to the database 16 at step 54. Once the drop is complete, at step 56, the storage manager 12 may send a storage drop complete signal back to the database client 14 at step 58.

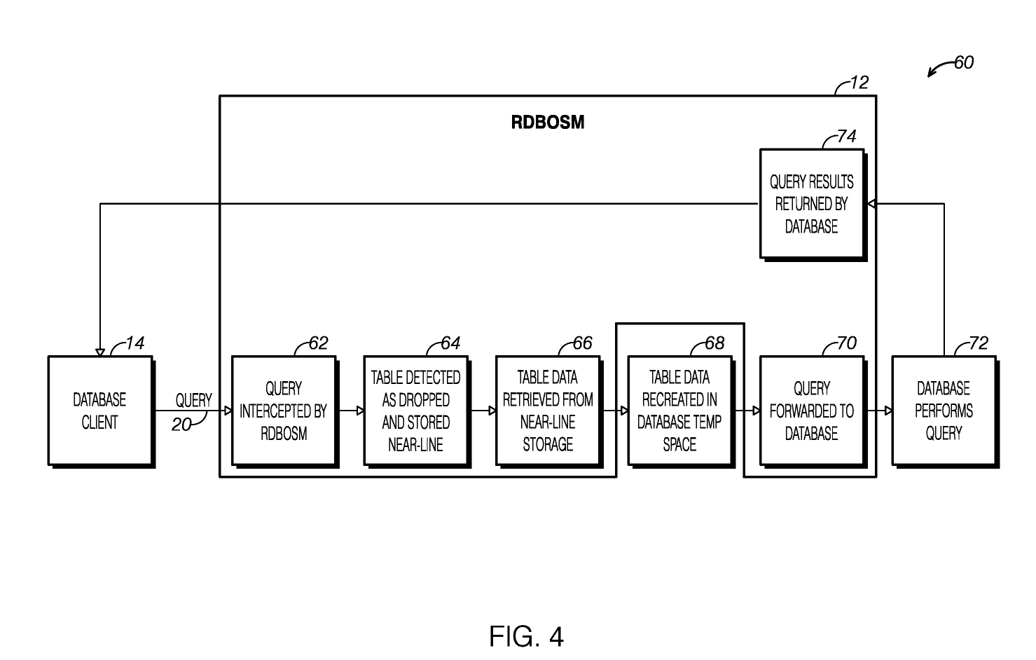

Referring to FIG. 4, a logic flow diagram 60 slows how the storage manager 12 handles a query on a previously dropped table. A query 20 is sent by the database client 14 and is intercepted by the storage manager 12 at step 62. At step 64, the storage manager 12 detects that the table is a dropped table and was stored in the data repository 18 (see FIG. 1). At step 66, the data from the dropped table is retrieved from the data repository 18 and, at step 68, the table data is restored in the database 16. In some embodiments, the table data may be restored in a temporary space in the database 16, where this data may be later deleted or overwritten. In other embodiments, the table data is restored permanently to the database 16. In some embodiments, the storage manager 12 may include a counter to determine how many times the dropped table was accessed by the database client 14 in a given time period. If this number exceeds a predetermined amount, the table data may be permanently returned to the database 16.

Regardless of how the table data is returned to the database 16, at step 70, the query is forwarded to the database 16, where, at step 72, the database 16 performs the query. The query results are returned by the database in step 74 and delivered to the database client 14.

In some embodiments, step 64, where the storage manager 12 detects that the table was a dropped table, may be removed. In this embodiment, the query is sent to the database 16, where, when the database 16 sends back a table not found error, the storage manager 12 then recreates the table in the database and resends the query back to the database. Regardless of the method, the storage manager 12 prevents a table not found error for tables that were previously dropped from the database.

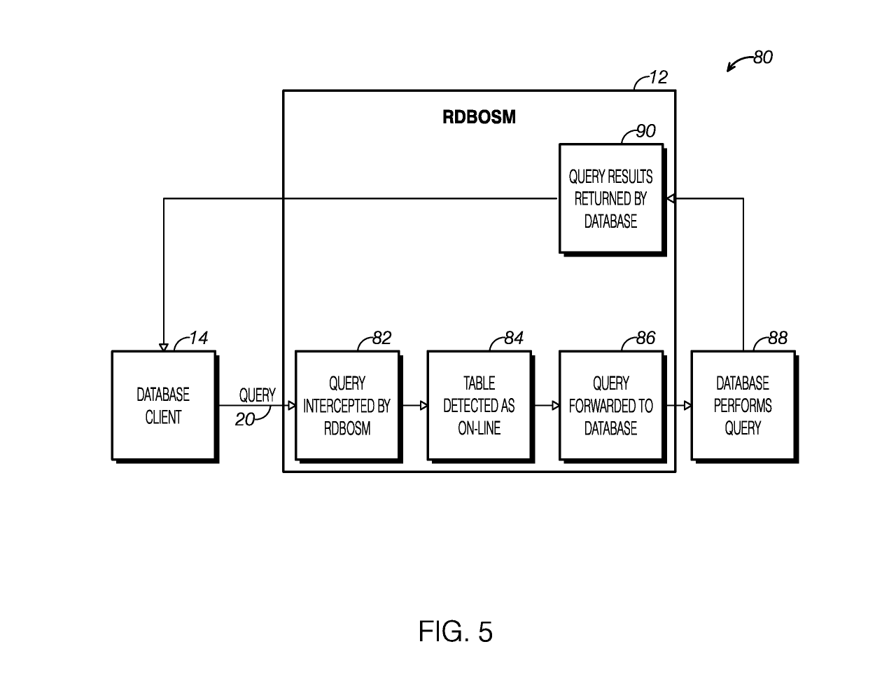

Referring now to FIG. 5, a logic flow diagram 80 shows how the storage manager 12 handles a query when the table is present in the database 16. Like with any query, the query 20 from the database client 14 is intercepted by the storage manager 12 at step 82. At step 84, it is determined that the table is detected as “on-line”, meaning that the table is present in the database 16. At step 86, the query is forwarded to the database 16 and, at step 88, the database 16 performs the query. Finally, at step 90, the query results are returned by the database 16 to the database client 14.

In some embodiments, the detection of the table as being on-line in step 84 may occur by querying the database 16 directly to determine whether a table not found error is generated. If no such error is returned, then the storage manager 12 knows that the table is present in the database 16.

The storage manager 12 of the present invention may not change any of the current database size management processes in use prior to its installation. For example, if the tables are summarized periodically, then the database client 14 sends a DROP TABLE command to the database 16 to remove the table from the database, this process can remain in place, as ordinarily practiced. The storage manager 12 is inserted to intercept the DROP TABLE command to make a backup of the table, away from the database 16, before it allows the table to be deleted therefrom.

The storage manager 12 may take various forms. For example, the storage manager 12 may be software, written in programming code and operable on a processor. The software may run on the database client or may run on a separate processor that is configured to receive database queries from the database client. In other embodiments, the storage manager 12 may be hardware including a processor for performing the functions described above. In still other embodiments, the storage manager 12 may be configured as a combination of software and hardware.

Many alterations and modifications may be made by those having ordinary skill in the art without departing from the spirit and scope of the invention. Therefore, it must be understood that the illustrated embodiments have been set forth only for the purposes of examples and that they should not be taken as limiting the invention as defined by the following claims. For example, notwithstanding the fact that the elements of a claim are set forth below in a certain combination, it must be expressly understood that the invention includes other combinations of fewer, more or different ones of the disclosed elements.

The words used in this specification to describe the invention and its various embodiments are to be understood not only in the sense of their commonly defined meanings, but to include by special definition in this specification the generic structure, material or acts of which they represent a single species.

The definitions of the words or elements of the following claims are, therefore, defined in this specification to not only include the combination of elements which are literally set forth. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a sub combination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what incorporates the essential idea of the invention.

What is claimed is:

1. A system for database management comprising:
a storage manager configured to receive queries of a database from a database client; and
a data repository configured to send and receive tables from the storage manager, wherein
when the storage manager receives, from the database client, a request to delete a table from the database, either through a command to drop a table from the database using common database syntax or through extension of database language by addition of data staging commands, the storage manager retrieves the table from the database and stores the table in a storage manager; and
when the storage manager receives a query made by a database client to access data in the table dropped from the database, the storage manager restores the table to the database before forwarding the query thereto.

2. The system of claim 1, wherein the storage manager includes a query proxy engine for handling the queries, and a file manager engine, for interacting with the data repository.

3. The system of claim 2, wherein the query proxy engine includes a query table search routine, a table exception handler and a query submission proxy handler.

4. The system of claim 2, wherein the file manager engine includes a dropped table list and a file handler.

5. A method for managing size of a database, comprising:
intercepting, by a storage manager, a request to delete a table from the database, either through a command to drop a table from the database using common database syntax or through extension of database language by addition of data staging commands;
retrieving the data from the database before issuing the command to the database;
storing the table into a data repository; and
issuing the request to the database after the step of storing the table into a data repository is complete.

6. The method of claim 5, further comprising:
intercepting a query of the database made by a database client;
determining whether the query is of a dropped table no longer in the database but stored in the data repository;
when the query is of a dropped table, retrieving the dropped table from the data repository and restoring the dropped table to the database; and
sending the query to the database.

7. The method of claim 6, wherein the step of determining whether the query is of the dropped table includes sending the query to the database and, if a table not found error is generated by the database, intercepting the error and making a positive determination that the query is of the dropped table.

8. The method of claim 5, wherein the data repository includes data storage separate from the database.

9. The method of claim 5, wherein the dropped table is restored to a temporary space in the database.

10. The method of claim 5, wherein when the query is of a non-dropped table, the query is sent to the database and the results returned to the database client.

11. The method of claim 5, further comprising maintaining a dropped table list within the storage manager.

12. A method for maintaining a database, comprising:
intercepting, by a storage manager, a request to delete a table from the database, either through a command to drop a table from the database using common database syntax or through extension of database language by addition of data staging commands;
storing the table into a data repository;
storing a table name of the table into a dropped table list of the storage manager;
issuing the request to the database after the step of storing the table into the data repository;
intercepting a query of the database made by a database client;
determining whether the query is of a dropped table no longer in the database but stored in the data repository;
when the query is of a dropped table, retrieving the dropped table from the data repository, restoring the dropped table to the database, and sending the query to the database; and
when the query is of a non-dropped table, sending the query to the database.

13. The method of claim 12, wherein the step of determining whether the query is of the dropped table includes sending the query to the database and, if a table not found error is generated by the database, intercepting the error and making a positive determination that the query is of the dropped table.

14. The method of claim 12, wherein the data repository includes data storage separate from the database.

15. The method of claim 12, wherein the dropped table is restored to a temporary space in the database.
